(19) United States
(12) Patent Application Publication
(10) Pub. No.: US 2020/0049355 A1
(43) Pub. Date: Feb. 13, 2020

(54) FLAT SOLAR CHIMNEY FOR PASSIVE REDUCTION OF BUILDING COOLING LOADS

(71) Applicant: King Fahd University of Petroleum and Minerals, Dhahran (SA)

(72) Inventors: Jihad H. Al-Sadah, Dhahran (SA); Esmail Mohamed Ali Mokheimer, Dhahran (SA); Mohammad Raghib Shakeel, Dhahran (SA)

(21) Appl. No.: 16/059,710

(22) Filed: Aug. 9, 2018

(51) Int. Cl. F24F 5/00; F03G 6/04

(52) U.S. Cl. CPC F24F 5/0046; F05B 2260/24; F24F 2005/0064; F03G 6/045

(57) ABSTRACT

A flat solar chimney in accordance with the invention reduces a building's cooling load by dissipating the solar energy outside the building. What Applicants have done is construct an outer wall having an inner air space before the building structure. The solar light is absorbed by the outside layer which includes a porous metal layer. The heated high surface area foam metal creates a convective air flow in the channel that extends vertically with openings at the bottom and top. This flow dissipates the absorbed heat and is totally external to the building's interior.

In a further embodiment of the invention, a plurality of rectangular slats either horizontally or vertically disposed act as venetian style blinds. The dynamic blinds allow visual function or the solar chimney as per need.

### FIELD OF THE INVENTION

This invention relates to a solar chimney for the passive reduction of the cooling load on a building during periods of elevated temperatures.

### BACKGROUND OF THE INVENTION

In hot and arid climates such as Saudi Arabia the electricity consumption drastically rises in the summer months as the domestic demand for air conditioning rises. According to the Joint Organizations Data Initiative (JODI), Saudi Arabia burned 0.9 million barrels per day (bbl/d) of crude oil in July 2014, the highest ever recorded in JODI data for the month of July and the highest overall since August 2010.

Electricity and Cogeneration Regulatory Authority (ECRA), Saudi Arabia, reported that the residential sector in Saudi Arabia consumes more than half of the total electricity generated in Saudi Arabia, of this 70% of the energy is used to meet the air conditioning load.

The heat from the ambient is generally conducted through the concrete/brick walls inside the buildings. A significant amount of electricity is used to bring down the temperatures inside the building to comfortable levels. The cooling load can be reduced if the amount of heat penetrating inside the buildings through the outer walls can be reduced.

A U.S. Pat. No. 246,626A by Morse in 1881, describes a heating ventilation system, which allows solar radiation passing through a glass wall to fall on a metal/blackened surface. Air is circulated over the back of the blackened surface to heat it and the heated air is recirculated into the building. A modified version of the above described patent suggested by Trombe (French Pat. No. FR1152129, 1958), has gained popularity since the 1960s to heat the insides of a building in colder regions. A wall is built on the winter sun side of the building with an external layer of glass adjacent to the wall creating a channel between them. The wall of the building is blackened to enable solar radiation to be absorbed, converted to sensible heat and stored in the thermal mass of the wall. The outer glass layer serves two purposes: contain the air in the channel and reduces the thermal radiation loss from the wall. Air absorbs heat from the blackened wall thus its density is reduced and it starts moving upward by convection. This heated air is then passed into the building. Trombe in another patent (French Pat. No. FR7123778) suggested cooling of the enclosed building by exhausting hot air through the Trombe wall and inducting cold air inside the building through another opening located on a different wall. This method can only be used in cold climatic conditions to warm the insides of the buildings.

Another U.S. patent (U.S. Pat. No. 4,111,359, 1978) Trombe further discussed an improvement of the previous design for cooling by suggesting to place the collector enclosure on the top of an inclined roof mainly because the vertical collectors attached to vertical walls may not receive enough solar radiation, however this might not be so true for hot countries like Saudi Arabia which have ample of solar radiation throughout the year and where inclined roofs are not very common.

Haugeneder et al. (U.S. Pat. No. 4,372,373) discloses a casing for a building having an absorbing and heat exchange layer, wherein the operation for heating the building, has the function of stopping the loss of heat from the inside to the outside and, on cooling operation, of stopping the transfer of heat from the outside to the inside of the building. A clear glass or opaque outer casing may be placed spaced apart from the absorbing and heat exchange layer. The air either originates or terminates from inside the building. The proposed two air channels and the air moves across the absorber which is permeable to air movement which may contain horizontal movement.

Yang et al. (Chinese Patent No. 203628926) discloses a solar heating ventilation system of a building. It is mainly composed of a glass cover plate, a solar heat collecting plate attached to a heat storage wall which is the structural wall. The main purpose is to do ventilation from the building on back of convective air flow. This is done by have two sets of dampers on the internal wall connecting building interior to the air channel. Having the building wall as heat storage device makes it incompatible with hot climates.

Bushong (U.S. Pat. No. 9,318,996) has employed porous metal layer as a solar thermal collector of solar light. The air is then forced through this structured porous material to be heated then used in warming the building. The air does not travel in a large connected space that can be called an air channel.

Christensen (U.S. Pat. No. 7,694,672) invention is to do ventilation from the building on the back of convective air flow. He proposed that air comes from the building by crossing an air permeable solar absorber then re-enter the building from a specific vent. He employs an outer glass layer to trap the heat in the solar absorber.

The above-mentioned patents describe a method of either heating or cooling in cold climatic conditions, which may not be applicable in hot arid climates. As such the use of internal cooling equipment is a necessity. However, the current invention aims at bringing down the cooling load thus significantly reducing the electrical power consumption. The same equipment can also be used to heat the air inside the building as suggested by patents mentioned above. Before proceeding to describe the present invention, Applicants want to highlight points where their work is different from Morse & Trombe.

In Applicants' invention, a modified outer layer is used to reduce the amount of heat passing through an outer wall of the building. The sun's light is absorbed in a layer that is not in thermal contact with the building. An outer glass layer traps in heat by preventing infrared radiation from escaping. The air in the channel is heated by the absorbent layer. This air does not enter into the building but is circulated outside by natural convection. The process of venting the hot air away from the building, reduces the cooling load. Other variations include utilization of hot air in regeneration of an absorption cooling system.

### SUMMARY OF THE INVENTION

In a preferred embodiment of the invention a flat solar chimney reduces a building's cooling load by dissipating solar energy outside the building as opposed to conducting it to the inside of the building. What Applicants have done is to construct an outer transparent or translucent wall having an inner surface spaced from a sun-facing outer wall of a building and providing a foam metal layer fixed to an inner surface of the outer transparent wall and forming an upwardly extending channel on the outside of the building. In a preferred embodiment of the invention, the flat solar chimney includes a porous foam metal layer fixed to an inner surface of the outer transparent wall. In a first and second modification the layer of porous metal are replaced by a layer of porous stone and a layer of porous cement, respectively.

The channel includes an opening near the bottom of the building and a second opening near the top of the building so that cooler air near the base of the building moves upwardly in the channel by convection. This heated air exits the channel at or near the top of the building without entering the building and exits away from the building. In the preferred embodiment of the invention a plurality of heat transmitting fins extend from a porous metal heat absorber into the channel for increasing the heat transfer to air within the channel.

In one embodiment of the invention, the solar chimney includes a plurality of venetian type blinds horizontally or vertically disposed in the solar chimney.

### BRIEF DESCRIPTION OF THE DRAWINGS

FIG. 1 is a side view of a solar chimney in accordance with a first embodiment of the invention;

FIG. 1A is a front view looking at or through a spaced apart transparent or translucent glass wall of a building that faces the winter sun;

FIG. 1B is a is a side view illustrating the positioning of the glass transparent wall with respect to the two triangular supports and one ground support together with the foundation of the south facing wall of the building;

FIG. 1C is a perspective view of a triangular support for positioning the transparent wall with respect to a south facing outer wall of the building;

FIG. 1D is a perspective view of a positioning support for supporting the separate glass wall positioned with respect to the south facing outer wall of the building;

FIG. 2 is a schematic side view of a plurality of heat conducting fins extending into an upwardly extending channel of a solar chimney in accordance with the invention;

FIG. 3 is a cross sectional view of a transmitting wall of a flat solar chimney for reducing a building's cooling load by deflecting solar energy away from a building as opposed to the inside of the building;

FIG. 4 is a further embodiment of the invention illustrating a plurality of heat transferring fins extending into an upwardly extending channel;

FIG. 5 illustrates an additional embodiment of the invention wherein an enclosed venetian style blind assembly includes a plurality of rotatable louvers or slats for directing the solar energy into an upwardly extending channel or the like;

FIG. 6 is a further illustration of FIG. 5 showing the blinds or louvers in an open position;

FIG. 7 is a top or plan view looking down on the louvers in the enclosed portion of a solar chimney;

FIGS. 8 and 9 illustrate a solar chimney as shown in FIGS. 6 and 7 and including enclosed blinds or louvers that are pivotal about an axis through the center of each of said louvers or blinds;

FIG. 10 is a top or plan view of a blind as shown FIGS. 8 and 9 in which the blinds are in an open position;

FIG. 11 is a side view of the rotatable blinds or louvers rotatable about axes extending through the midsection of each blind;

FIG. 12 is a further illustration of the blinds in FIG. 11 but a side view of the blinds in an open position;

FIG. 13 is a top or plan view looking down on an open blind that is rotatable about its axis running through its midsection;

FIG. 14 illustrates a solar chimney in accordance with a further embodiment of the invention and which includes an electric generator illustrated schematically as a fan at the top of the upwardly extending channel; and

FIG. 15 illustrates a further solar chimney wherein the invention is used for heating an interior of a building.

The invention will now be described in connection with the accompanying drawings wherein like reference numbers are used to identify like parts.

### DETAILED DESCRIPTION OF THE PREFERRED EMBODIMENTS OF THE INVENTION

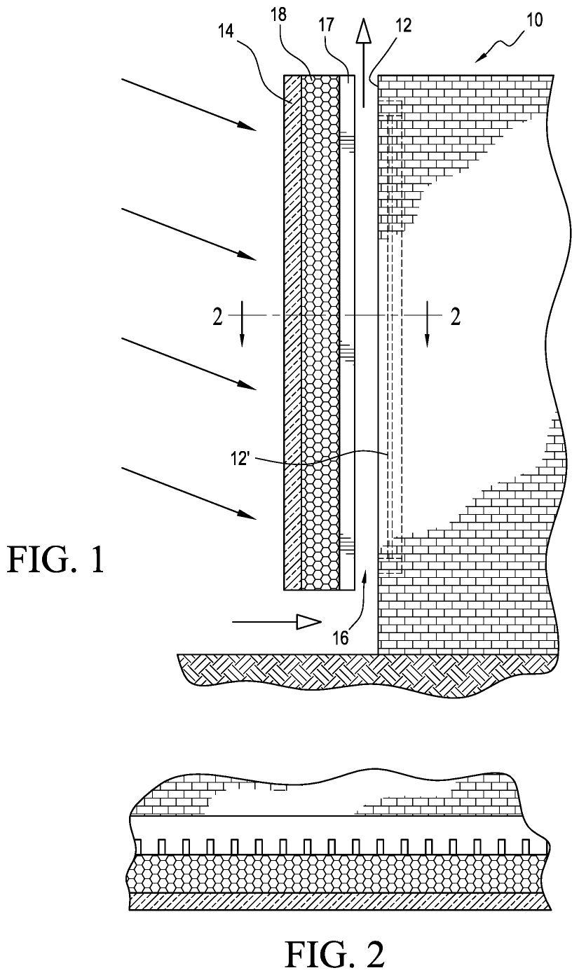

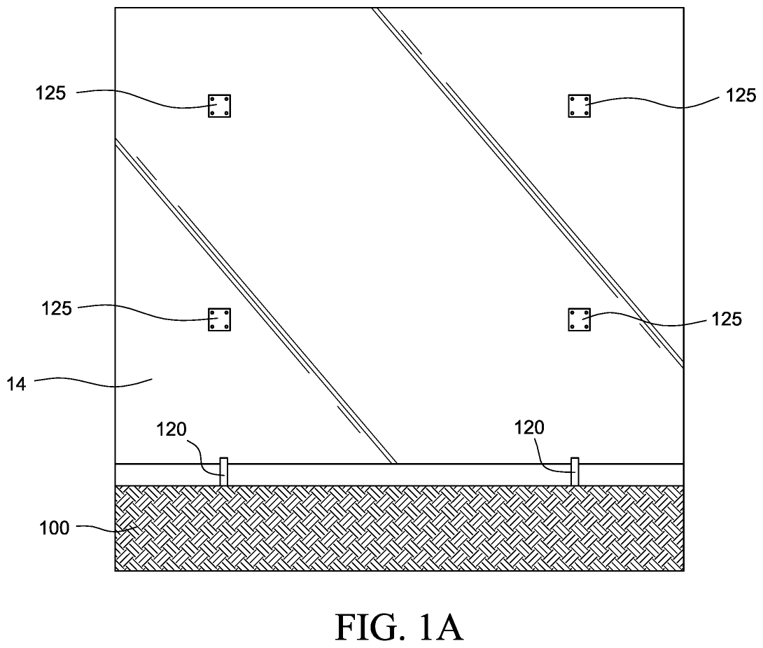

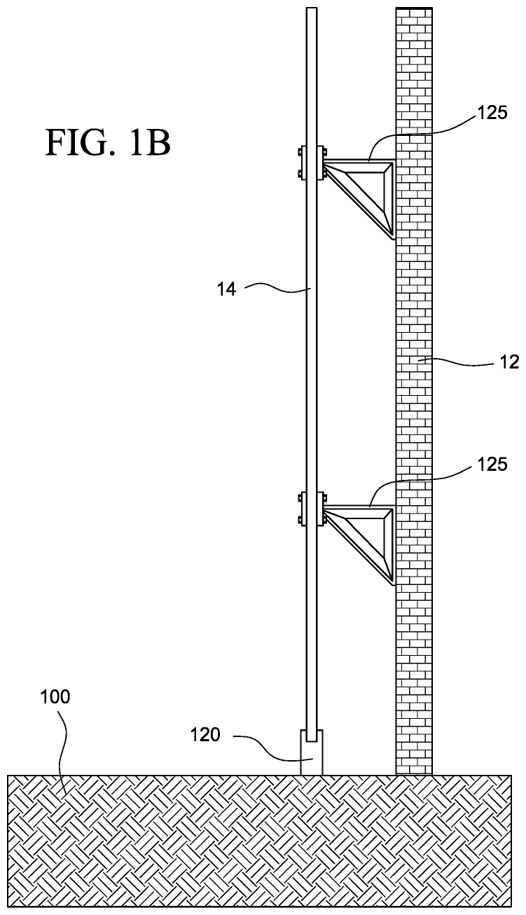

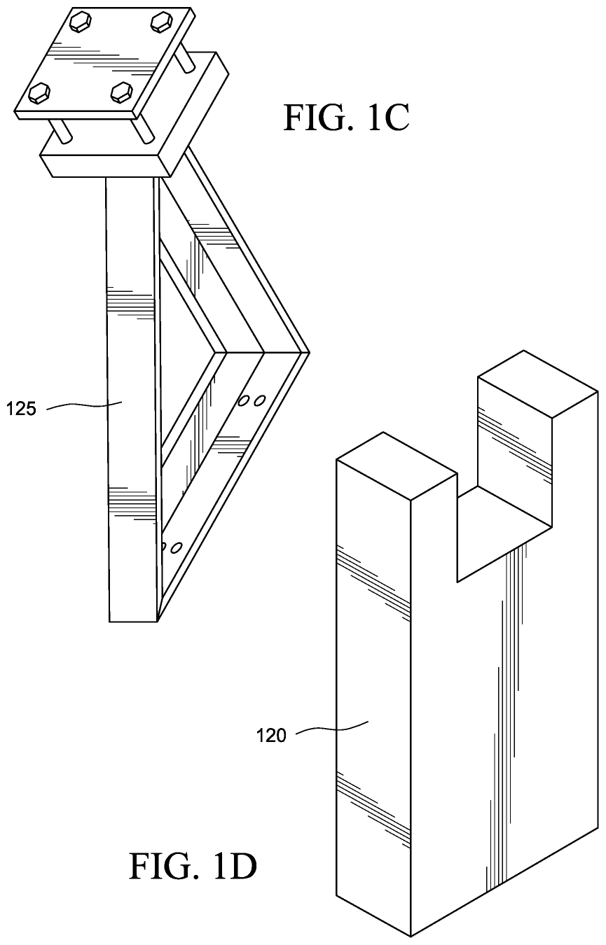

In a first embodiment of the invention, a flat solar chimney for reducing the cooling load on a building during periods of excessive heat includes a flat solar chimney as shown in FIG. 1. As illustrated, a building 10 includes an outer wall 12 that is preferably facing the sun and a transparent or translucent separate glass wall 14 that is spaced apart from the sun-facing wall 12 of the building by 10 to 20 centimeters and forms an upwardly extending channel 16 between the sun-facing building wall 12 and the separate transparent wall 14. The channel 16 directs heated air upwardly from a lower point of the building 10 to the top 13 of the building 10.

As illustrated in FIG. 1A a transparent wall 14 is supported in front of a sun-facing building wall 12 and supported by a pair of ground based supports 120 with a support on each side of the south facing wall. As illustrated, the transparent wall 14 and sun-facing wall 12 of the building form an upwardly extending channel 16 with openings at the bottom and the top of the transparent wall 14. As illustrated, the upwardly extending channel extends from the bottom to the top of the building with a channel defined in between the transparent wall and the south facing building wall extending upwardly to direct a flow of air due to convection.

FIG. 1B is a schematic side illustration of the upwardly extending channel between the transparent wall and the south facing building wall with a pair of triangular supports spacing the transparent wall 14 from the south facing building wall. As shown, a ground support 123 and two triangular supports 125 space the wall away from the south facing building wall. Further detail of a triangular support is shown in FIG. 1C.

In FIG. 1D a ground support 120 positions the wall together with the triangular supports 125 in FIG. 1D. As illustrated in FIG. 1D, a metal support rest on or extends into a ground level foundation. The bottom of the wall extends into a cut out in the top of the support 120.

In FIG. 1 the dynamic process is described. The upwardly extending channel 16 has an opening at the bottom of the building 10 or at the bottom thereof and a second opening at the top of the building 10 which is sealed to prevent heated air from entering the building from the channel 16. The transparent or translucent wall 14 includes an outer glass support 15 and a porous metal absorber 18 in contact with the glass support 15 and plus an array of outwardly extending heat transmitting fins 19 or elements that extend outwardly into the channel 16.

The porous metal absorber 18 is immediately in back of and behind and/or in contact with the rear surface of the glass wall 14 and may include a conventional array 19 of metal fins extending rearwardly from the porous metal absorber 18 and extending rearwardly from a layer 20 of black paint on the rear surface of the absorber 19 and into the upwardly extending channel 16.

The outwardly extending fins are shown schematically as a series of short stubs 21 in FIG. 2 but in reality are flat fins similar to those in a core of an automotive radiator that extends into the channel 16.

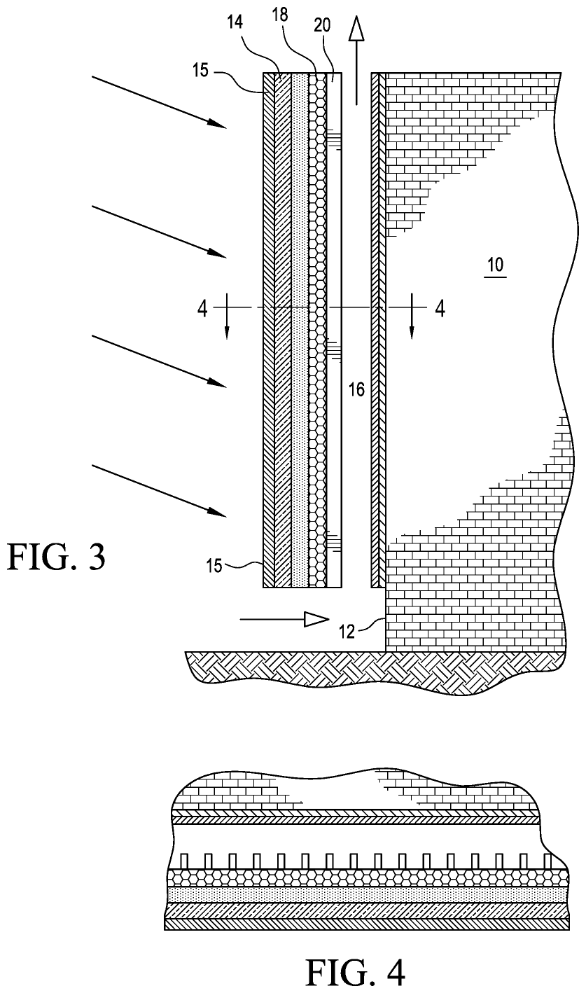

As shown in FIG. 3, the transparent or translucent wall includes a glass support member 14 with an anti-reflective coating on a front surface on the glass wall 14. The glass wall 14 may also include a translucent aerogel layer 17 on the back of the transparent member 14. An aerogel layer would allow the solar radiation to pass through the outer transparent glass wall into the air channel and prevent it from reflecting back out the glass wall to the ambient. In other words, it works to trap the heat in the vertical air channel.

The aerogel layer is followed by a layer of foam metal absorbers 18 with a coating of black paint 19 on a rear surface thereof and finally an array 22 of thin metal sheet material 21 that is similar in thickness to the metal in an automotive radiator. Aerogel increases the temperature of the metal foam which eventually improve the natural convection.

As illustrated in FIG. 1, the building's sun-facing outer wall 12 is preferably sealed to prevent heat from the upper extending channel 16 from passage into the inner structure of the building 10. As illustrated in FIG. 3, the sun-facing outer wall 12 of the building 10 may preferably include a layer 17 of insulation to help protect the outer wall of the building from permitting heat produced by the sun's rays and a low emissivity coating on top of the layer 17. Layer 17 is not a thermal insulation but it is a low emissivity coating to reduce radiative heat transfer to the building or wall 12.

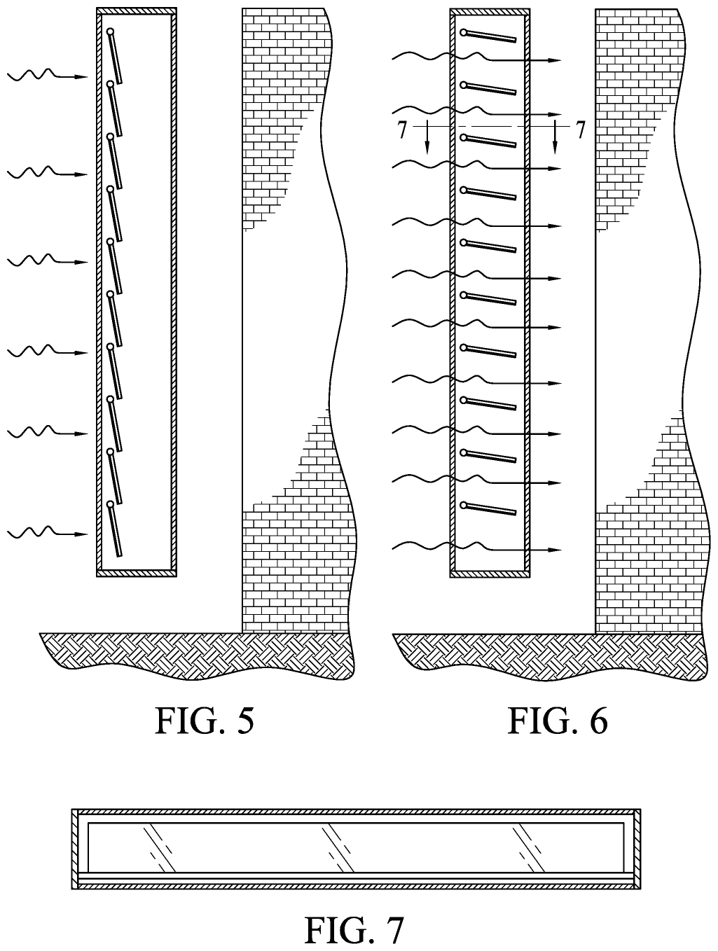

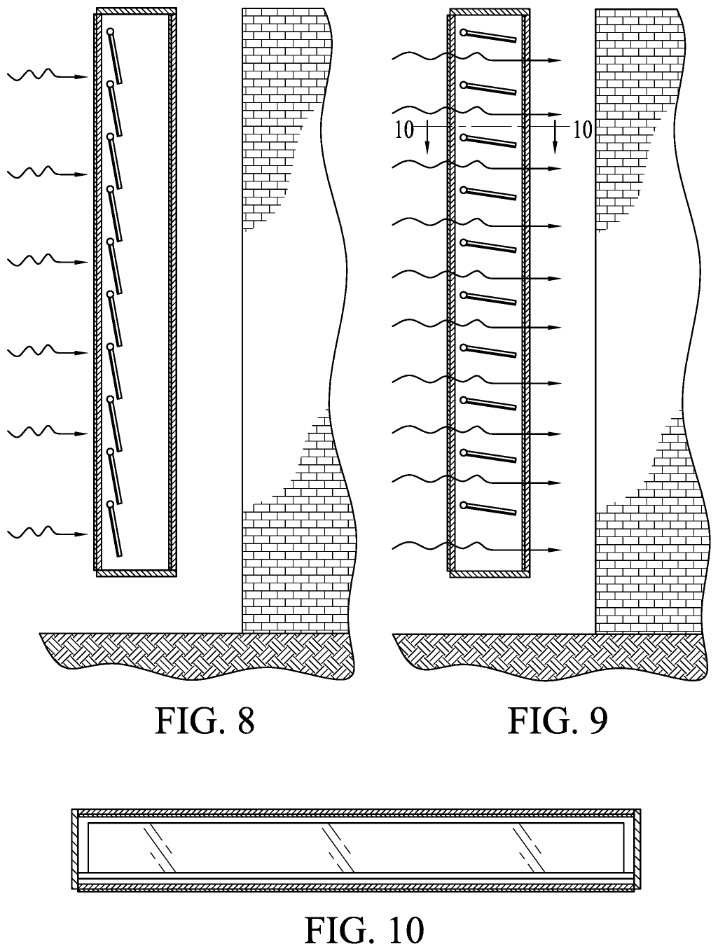

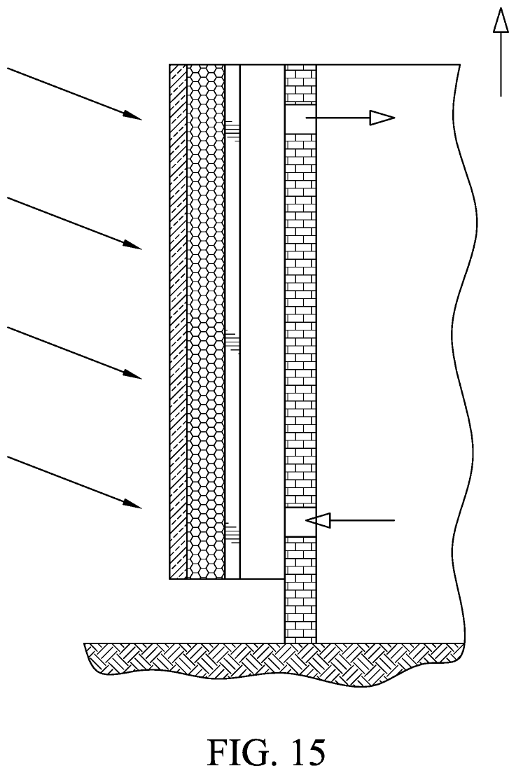

Further embodiments of the invention are shown in FIGS. 5-17 wherein a separate wall is outwardly moved away from the sun-facing wall 24 of the building 10 by about 10 to 20 centimeters and includes a pair of parallel walls 21 and 23 comprising a plurality of rotatable rectangular slats disposed in an enclosed box like chamber.

As shown, each of the chambers include a plurality of rotatable rectangular wooden, metal or plastic blades that are rotatable about parallel axes that may be horizontally or vertically disposed to rotate about the leading or trailing or midsection of each blind. The blinds which are basically rectangular shaped are rotatable about a leading edge, trailing edge or the midsection of each blind.

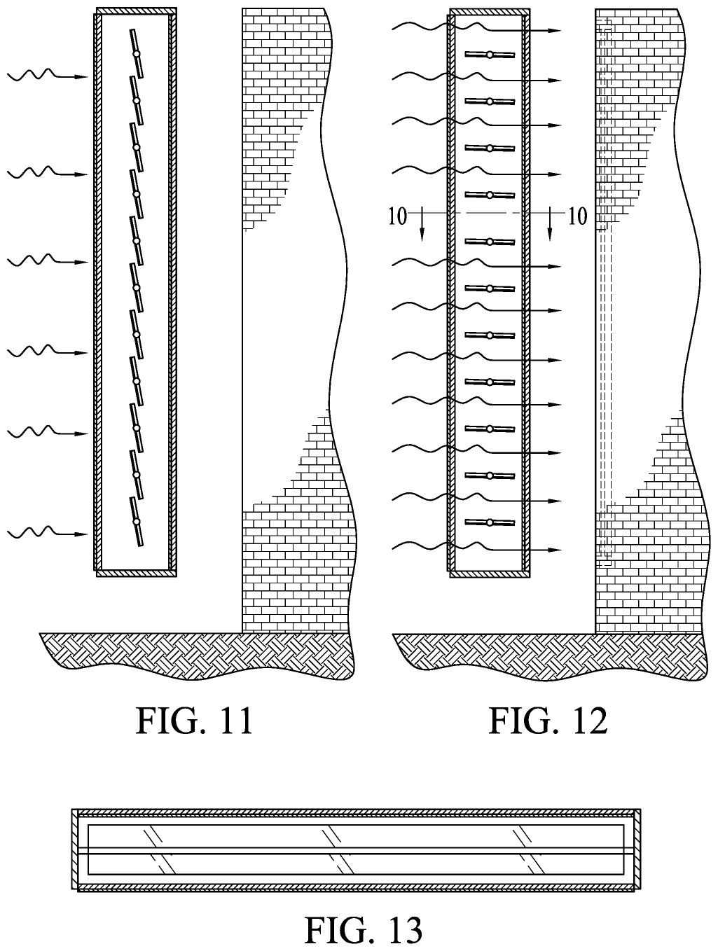

For example, FIGS. 1-10 illustrate blinds that are rotatable about a leading or trailing edge while FIGS. 5-13 illustrate the case where the blinds are rotatable about the central axis. It should also be recognized that the rotatable axes may be rotatable about a horizontal or vertical axes. Such axes may be disposed on the leading or trailing edges or the midsection of each of the blinds. For contrast, FIGS. 11-13 show blinds that are rotatable about the midsection of the blinds.

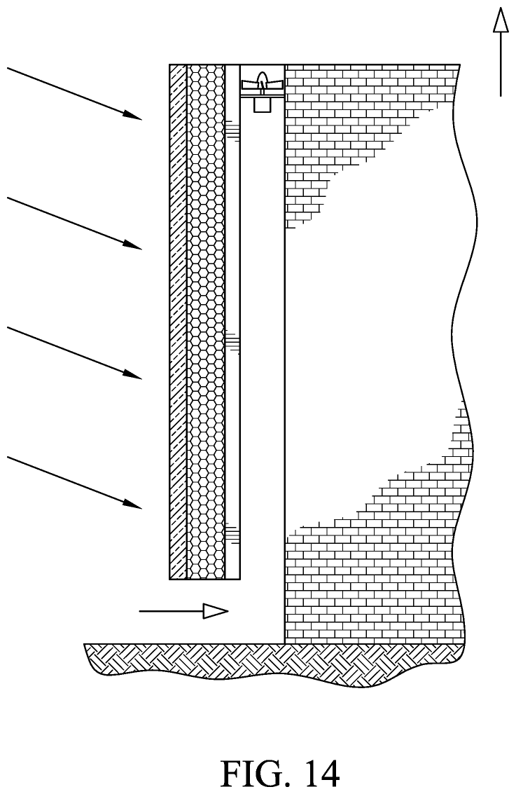

FIGS. 14 is a schematic illustration of a still further embodiment of the invention wherein a fan is shown at the exit of the upwardly extending channel near an exit near the top of the building for enhancing natural convection. Other electricity generating or other devices can be powered as desired.

While the invention has been illustrated for cooling a building during periods of elevated temperatures it should be recognized that the invention may be used for other applications without departing from the scope of the claims.

### REFERENCES

1. JODI, http://www.eia.gov/todayinenergy/detail.cfm?id=18111

2. ECRA, Saudi Arabia annual report 2014

3. Sparrow, E. M. and Acevedo, L. F. A., 1985. Vertical-channel natural convection spanning between the fully-developed limit and the single-plate boundary-layer limit. International Journal of Heat and Mass Transfer, 28(10), pp.1847-1857.

4. Bouchair, A., Fitzgerald, D. and. Tinker, J. A., 1988. Moving air using stored s energy. Proceedings of 13TH National Passive Solar.

5. Du, Z. G. and Bilgen, E., 1990. Natural convection in composite wall collectors with porous absorber. Solar Energy, 45(6), pp.325-332.

6. Awbi, H. B. and Gan, G., 1992. Simulation of solar-induced ventilation. Renewable Energy Technology and the Environment, 4, pp.2016-2030.

7. Chaturvedi, S. K., Chen, D. T. and Mohieldin, T. O., 1992, July. Ventilation characteristics of a Trombe wall thermosyphon loop. In Proc. Int. Symp. on Room Air Conditioning and Ventilation Effectiveness (pp. 624-631).

8. Barozzi, G. S., Imbabi, M. S. E., Nobile, E. and Sousa, A. C. M., 1992. Physical and numerical modelling of a solar chimney-based ventilation system for buildings. Building and Environment, 27(4), pp.433-445.

9. Barisal, N. K., Mathur, R. and Bhandari, M. S., 1993. Solar chimney for enhanced stack ventilation.

10. Bouchair, A., 1994. Solar chimney for promoting cooling ventilation in southern Algeria. Building Services Engineering Research and Technology, 15(2), pp.81-93.

11. Andersen, K. T., 1995. Theoretical considerations on natural ventilation by thermal buoyancy (No. CONF-950624). American Society of Heating, Refrigerating and Air-Conditioning Engineers, Inc., Atlanta, Ga. (United States).

12. Warrington, R. O. and Ameel, T. A., 1995. Experimental studies of natural convection in partitioned enclosures with a Trombe wall geometry. Journal of solar energy engineering, 117(1), pp.16-21.

13. Gan, G., 1998. A parametric study of Trombe walls for passive cooling of buildings. Energy and buildings, 27(1), pp.37-43.

14. Hinnlabh, J., Kongduang, W., Namprakai, P. and Khedari, J., 1999. Study of natural ventilation of houses by a metallic solar wall under tropical climate. Renewable Energy, 18(1), pp.109-119.

15. Afonso, C. and Oliveira, A., 2000. Solar chimneys: simulation and experiment. Energy and Buildings, 32(1), pp.71-79.

16. AboulNaga, M. M. and Abdrabboh, S. N., 2000. Improving night ventilation into low-rise buildings in hot-arid climates exploring a combined wall-roof solar chimney. Renewable energy, 19(1), pp.47-54.

17. Ong, K. S., 2003. A mathematical model of a solar chimney. Renewable Energy, 28(7), pp.1047-1060.

18. Hirunlabh, J., W. Kongduang, P. Namprakai, and J. Khedari. “Study of natural ventilation of houses by a metallic solar wall under tropical climate.” Renewable Energy 18, no. 1 (1999): 109-119.

19. Andersen, K. Terpager. Theoretical considerations on natural ventilation by thermal buoyancy. No. CONF-950624. American Society of Heating, Refrigerating and Air-Conditioning Engineers, Inc., Atlanta, Ga. (United States), 1995.

20. Flourentzou, F., J. Van der Maas, and C-A. Roulet. “Natural ventilation for passive cooling: measurement of discharge coefficients.” Energy and buildings 27, no. 3 (1998): 283-292.

21. Swinbank, W. CQJR. “Long-wave radiation from clear skies.” Quarterly Journal of the Royal Meteorological Society 89, no. 381 (1963): 339-348.

22. Bergman, Theodore L., Frank P. Incropera, and Adrienne S. Lavine. Fundamentals of heat and mass transfer. John Wiley & Sons, 2011.

23. Calmidi, V. V., and R. L. Mahajan. “Forced convection in high porosity metal foams.” Journal of Transfer 122, no. 3 (2000): 557-565.

24. Pack, J. W., B. H. Kang, S. Y. Kim, and J. M. Hyun. “Effective thermal conductivity and permeability of aluminum foam materials1.” International Journal of Thermophysics 21, no. 2 (2000): 453-464.

1. A flat solar chimney for reducing a building's cooling load during periods of excessive heat, said solar chimney comprising:
an outer sun-facing wall of a building and an outer transparent wall having an inner surface outwardly spaced from the sun-facing wall of the building, and an opaque porous layer fixed to said inner surface of said outer transparent wall and spaced from said outer sun-facing wall of said building to thereby form an upwardly extending channel for convection of heated air; and
an opening for said channel at a lower portion of said building and a second opening at an upper portion for heated air to flow by convection from the lower portion to the upper portion and exits said channel at said upper portion of said building without entering an inner space of said building.

2. A flat solar chimney for reducing a building's cooling load according to claim 1, which includes a plurality of heat transmitting fin like elements extending outwardly from said porous metal absorber for transmitting heat into said channel.

3. A flat solar chimney for reducing a building's cooling load according to claim 2, which includes an anti-reflective coating on said outer surface of said transparent wall.

4. A flat solar chimney for reducing a building's cooling load according to claim 2, in which said sun-facing building wall includes a layer of thermal insulation on an outer surface thereof.

5. A flat solar chimney for reducing a building's cooling load according to claim 4, in which said transparent or translucent wall includes an outer coating of low emissivity paint thereon.

6. A flat solar chimney for reducing a building's cooling load according to claim 2, which includes a glass transparent wall and a porous metal wall and an aerogel layer between said glass wall and said porous metal wall.

7. A flat solar chimney for reducing a building's cooling load according to claim 2, which includes a plurality of heat conducting fins extending into said channel from said porous metal layer.

8. A flat solar chimney for reducing a building's cooling load according to claim 2, which includes a plurality of horizontally disposed rectangular parallel blinds.

9. A flat solar chimney for reducing a building's cooling load according to claim 2, which includes a plurality of vertically disposed parallel rotatable parallel rectangular blinds.

10. A flat solar chimney for reducing a building's cooling load according to claim 8, in which said blinds are rotatable about a series of parallel axis (is that horizontal or vertical) fixed to an edge of each of said blinds.

11. A flat solar chimney for reducing a building's cooling load according to claim 8, in which each of said blinds is rotatable about one of a plurality of axis extending through a center of each of said blinds.

12. A flat solar chimney for reducing a building's cooling load according to claim 9, in which each of said blinds are rotatable about an edge of said blinds.

13. A flat solar chimney for reducing a building's cooling load according to claim 9, in which each of said blinds is rotatable about a vertical axis and blinds can be open as per user preference to see through from inside of the building to the outside.

14. A flat solar chimney for reducing a building's cooling load according to claim 9, in which a fan at the top portion of said channel of the upwardly extending channel induces forced convection of air.

15. A flat solar chimney for reducing a building's cooling load according to claim 2, in which said sun-facing wall of said building is sealed from the bottom to the top of said building to prevent heated air in said chamber from entering into the interior of said building.

16. A flat solar chimney for reducing a building's heating load in which said outer sun-facing wall of said building includes a first opening into said building from said upwardly extending channel and a second opening in an upper or top portion of said building to channel heat from said upwardly extending channel into the interior of said building.

17. The outward layer in claim 1 can also be opaque metallic, stone or concrete layer and has large surface area of metals that can be porous metal or fins toward the building side.

18. A flat solar chimney for reducing a building's cooling load according to claim 17, in which the material of claim 17 is a porous metal foam.

19. A flat solar chimney for reducing a building's cooling load according to claim 17, in which the material of claim 17 is a porous cement.

20. A flat solar chimney for reducing a building's cooling load according to claim 17, in which the material of claim 17 is a porous stone.
